(19) United States
(12) Patent Application Publication
(10) Pub. No.: US 2026/0357653 A1
(43) Pub. Date: Nov. 12, 2026

(54) HIGH-SPEED DOOR

(71) Applicant: Frinova GmbH, Pansdorf (DE)

(72) Inventor: Wilhelm DÜCK, Lübeck (DE)

(21) Appl. No.: 19/130,704

(22) PCT Filed: Oct. 20, 2023
(86) PCT No.: PCT/EP2023/079270

§ 371 Date: May 16, 2025

(30) Foreign Application Priority Data
Nov. 17, 2022 (EP) 22208121.8

(51) Int. Cl. E06B 9/58

(52) U.S. Cl. CPC E06B 9/581

(57) ABSTRACT

A quick-action door has a flexible door leaf (12; 14), at least one rotatable shaft (8) configured to wind up the door leaf (12; 14), and a door frame (2), against which, in the closed state of the quick-action door, the door leaf (12; 14) abuts with at least one contact region (28) so as to form a seal. First magnetic holding elements (26) are arranged in the door frame (2) and second magnetic holding elements (30; 44) are arranged in the door leaf (12; 14) in the contact region (28), such that the door leaf (12; 14) is held magnetically in contact with the door frame (2).

### CROSS REFERENCE TO RELATED APPLICATIONS

This application is a United States National Phase Application of International Application PCT/EP2023/079270, filed Oct. 20, 2023, and claims the benefit of priority under 35 U.S.C. § 119 of European Application 22208121.8, filed Nov. 17, 2022, the entire contents of which are incorporated herein by reference.

### TECHNICAL FIELD

The invention relates to a quick-action door.

### BACKGROUND

Quick-action doors are used, for example, on doors in warehouses, in order to be able to open and close them quickly. They take the form of doors with a flexible door leaf, which for purposes of opening is wound onto a shaft. Such a door is of known art, for example, from WO 2016/131476 A1. These types of doors are used, for example, for the closure of cold storage or deep-freeze storage rooms, and must have sufficient insulation properties for this purpose. The doors should seal well against a door frame, but at the same time should be quick to open.

### SUMMARY

It is an object of the invention to provide a quick-action door with a flexible door leaf, which enables an improved sealing against a door frame.

This object is achieved by means of a quick-action door with features according to the invention. Preferred forms of embodiment ensue from the following description, the claims and the accompanying figures.

The quick-action door according to the invention has a flexible door leaf, which is attached to a rotatable shaft such that it can be wound onto the shaft by rotation of the latter. The shaft is connected to a suitable rotary drive, for example an electric motor, and can preferably be driven in both directions of rotation so that the door leaf can be wound on and later unwound again. In the course of the unwinding procedure, the movement of the door leaf can be assisted by gravity, or, if the weight of the door leaf is sufficient, it can also be promoted by gravity alone, at least in sections.

The quick-action door has a door frame against which the door leaf seals tightly when closed. This ensures that a contact region of the door leaf seals tightly against the door frame. The door frame has two side door frame parts that extend essentially vertically, which bound the door opening at the sides and serve to support and/or guide the door leaf in the region of its side edges. To ensure a tight seal, the door leaf can be guided in a guide, which can be configured so that one side of the guide presses the door leaf against the door frame when closed. The door frame and the door leaf are also configured so that the door leaf adheres to the surface of the door frame to ensure a sealed contact. This is achieved by magnetic forces. This design has the advantage that the door leaf and the door frame can be configured so that the door leaf abuts against the outside of the door frame and can move freely away from the door frame in one direction. This is an advantage in cold rooms, for example, as such a quick-action door can be opened from the inside by pushing it away from the door frame even if the drive fails. Damage to the door leaf is also prevented if, for example, a forklift truck accidentally drives into the closed door. In such a case, the door leaf can swing away from the door frame without having to be rolled up.

In order to attach the door leaf to the door frame magnetically, the door frame has first magnetic holding elements. These can be embedded in the door frame or applied to the surface of the door frame as a magnetic strip. The first magnetic holding elements are preferably arranged on the vertical sides of the door frame over the entire height of the door, such that the door leaf can be sealed tightly against the door frame over the entire height. Complementary to this, second magnetic holding elements are arranged in the door leaf, at least in one contact region, in such a manner that the door leaf is held magnetically in contact with the door frame when it is closed. The contact regions of the door leaf preferably extend along the side edges of the door leaf over its entire height. The second magnetic holding elements are preferably distributed over the entire height so that they can adhere to correspondingly distributed first magnetic holding elements.

A large number of individual second magnetic holding elements, for example metal plates, or metal platelets, are preferably, arranged in the door leaf, which are movable relative to one another. In this manner, the metal elements do not impair the flexibility of the door leaf, and do not prevent it from rolling up.

The first magnetic holding elements are preferably permanent magnets, and the second magnetic holding elements are preferably ferromagnetic metal elements, made, for example from steel. In principle, however, a reverse arrangement is also conceivable, in which the second magnetic holding elements are permanent magnets and the first magnetic holding elements are ferromagnetic metal elements. A design in which the first and second magnetic holding elements are permanent magnets is also possible, in which case the permanent magnets are aligned on the door frame and in the door leaf such that they attract each other.

The second magnetic holding elements are preferably embedded in the material of the door leaf, for example, are cast into at least one layer of material, or are enclosed between two layers of material. In a particular configuration, the door leaf can be made from felt material and the second magnetic holding elements, for example in the form of ferromagnetic metal elements, are further preferably embedded in the felt material, or are located inside the felt material, so that the contact region on its surface is not impaired by the second magnetic holding elements, and a sealed contact against the door frame can be achieved in this region by virtue of the flexibility of the material.

Furthermore, pockets can preferably be formed inside the felt material adjacent to at least one side edge, preferably adjacent to both vertical side edges, in which the second magnetic holding elements, for example ferromagnetic metal elements, are arranged. The pockets can, for example, be introduced as incisions from the side edge. The second magnetic holding elements, for example metal plates, can be inserted into these incisions from the side edge. After the second magnetic holding elements have been inserted, these pockets are preferably sealed or bonded on the side. In this manner, the second magnetic holding elements are securely held in the pockets in the interior of the felt material. The seal is preferably the same seal that is used to seal the entire side edge of the felt material, that is to say, as described below, it is preferably a seal that is applied in liquid form to the side edge, and can therefore also run into the pocket, and seal or bond it securely.

According to a further possible configuration, the second magnetic holding elements can be embedded in a contact element, preferably a contact strip, which is attached in the at least one contact region on the surface of the door leaf. Such a contact element, or contact strip, can protect or reinforce the door leaf in the contact region and can serve to ensure a sealed contact against the door frame. The contact element, or contact strip, is preferably elastic, which on the one hand ensures that it can be rolled up together with the door leaf, and on the other hand improves the seal against the door frame. Elastic materials such as elastic polymers or rubber can be used. Such a contact element, or contact strip, can be fixedly connected to the door leaf, for example by sewing and/or bonding.

In a further possible configuration, the second magnetic holding elements can be formed from ferromagnetic wires embedded in an elastic material, preferably rubber, for example by molding. This creates movable second magnetic holding elements that are protected by the embedding, and can easily be wound up with the door leaf. The ferromagnetic wires can preferably be embedded in the at least one contact element in the form of a contact strip. This creates a well-sealed contact region, and at the same time protects the ferromagnetic wires, in particular from corrosion, by embedding them in a surrounding material.

The door leaf is can preferably be made from a felt material. Felt has good insulating properties, sufficient flexibility for winding and, in addition, good durability. The felt material is can further be provided with a vapor diffusion-proof coating on at least one surface. The vapor diffusion-proof coating prevents moisture from penetrating into the felt material through the surface. Moisture penetration would be problematic, especially when the door is used as one that closes off a deep-freeze storage room, as the moisture could freeze in the felt material, and the felt material would then no longer be sufficiently flexible for the winding-on procedure. Furthermore, the moisture would impair the insulation properties. The vapor diffusion-proof coating is formed on at least one surface, preferably at least on the surface that is facing towards a room with air humidity. When used as a cold storage room door, this is in particular the warm side of the quick-action door.

In a preferred form of embodiment, the door leaf can be provided with a vapor diffusion-proof coating on each of its two surfaces that are facing away from each other. In this manner, moisture penetration is prevented on each side of the felt material. The vapor diffusion-proof coating preferably also has a smooth surface that is easy to clean, and in its appearance, for example its coloring, can be configured in a desirable manner.

The felt material of the door leaf is preferably a felt made from natural and/or artificial fibers. Woolen fibers can, for example, be used as the natural fibers. The felt preferably takes the form of a woolen felt, that is to say, a felt material that is preferably made entirely from natural wool. Such a woolen felt has good insulation properties, can be used over a wide temperature range, and furthermore, as a natural product, has good ecological properties. However, synthetic fibers can also be added to the felt material, or alternatively the felt material could be made entirely from synthetic fibers, depending on the application.

The felt material of the door leaf is preferably configured so that it can be used over a temperature range from −40 °C up to +80 °C; furthermore, preferably up to +150 °C. Thus, the door leaf is suitable for use in cold storage rooms or deep-freeze storage rooms as well as for applications in which heated rooms are to be closed off, for example rooms for the drying and/or curing of certain products.

In a preferred configuration of the invention, a vapor diffusion-proof coating of the door leaf is made from a plastic material and furthermore, preferably from a polyurethane material. Such plastic materials have good elasticity and flexibility, which is necessary to allow the door leaf to be wound on. Furthermore, such plastic coatings can easily be applied, for example, to a felt material, and can ensure the desired vapor diffusion-proof properties. A polyether-based polyurethane is particularly preferred. Such a material has the desired resistance to cold. However, other materials that exhibit the desired barrier effect against vapor can also be used. These can be suitable plastic materials, or also coatings with a metal content. Multi-layer coatings can also be used.

The vapor diffusion-proof coating of the door leaf is, furthermore, preferably configured such that it is flexible enough to allow the door leaf to be rolled up even at temperatures below 0 °C, and furthermore, preferably at temperatures below −20 °C. This flexibility and elasticity preferably ensures that the door leaf can be wound on, even with radii of curvature less than 10 cm, without the coating breaking or tearing. The desired elasticity at low temperatures enables the use of the quick-action door for the closure of deep-freeze storage rooms.

According to a further preferred form of embodiment, the vapor diffusion-proof coating of the door leaf can be configured to be UV-stable. This can be ensured by an additional surface coating, or, in the case of a single-layer coating, by a suitable coating material. The coating is considered to be UV-stable if, when exposed to daylight and direct sunlight, it has a service life that is customary for quick-action doors of this type. This is preferably at least five years, and furthermore, is preferably more than ten years. Particularly preferably, the UV-stability also ensures a color stability of the coating material, so that the visual properties of the door leaf remain essentially unchanged over its service life, even when it is exposed to sunlight.

According to a further possible configuration, the vapor diffusion-proof coating can be bonded to the felt material, and/or is cast, or fused, onto the felt material. The coating material can, for example, be applied in liquid or paste form to the surface of the felt material, and, if necessary, pressed against the latter before it then assumes its final strength. This can take place as a result of cooling or chemical hardening. Alternatively, or additionally, the coating material can be solvent-based. The application can, for example, be carried out by way of calendar rollers. However, it would also be conceivable to form the coating in the manner of a film, and then to bond it onto the felt material, for example by heating, or with the aid of an adhesive that is introduced between the film and the felt material. In this way, the felt material can be provided with a vapor diffusion-proof coating on one or both surfaces.

The side edges of the door leaf, which is made from a felt material, for example, are, furthermore, preferably sealed, preferably with a plastic material. If, for example, both surfaces of the felt material are provided with a coating, the side edges of the felt material remain free; these can then be closed off with a sealant. However, even if only one surface of the felt material is provided with the coating, it can be expedient additionally to seal the side edges. The sealing process preferably takes place with a material that corresponds to the material of the coating, or has similar chemical properties. Particularly preferably, a liquid sealant material is used, which can be drawn into the structure of the felt material from the side edge, and hardens within the structure, thereby sealing the side edge. A liquid plastic, such as a liquid silicone, could be used for this purpose. Furthermore, the sealant for the side edges is also preferably formed from a material that is vapor diffusion-proof. However, since the side edges are located in the region of a door frame, they are less exposed to large temperature differences, so that in some individual cases condensation of moisture is less likely in these regions, so that in these individual cases the edge sealant can be less diffusion-proof than the coating of the surfaces.

In a particular form of embodiment, the door leaf can comprise at least two interconnected layers of a felt material, which are preferably bonded together. On the one hand, the formation of a plurality of layers of felt material makes it possible to combine different felt materials. On the other hand, it also makes it possible to design door leaves with varying thicknesses, as is described further below, for example. Furthermore, in this manner it is possible to produce door leaves with a greater thickness. For example, two layers of felt, each 10 mm thick, can be joined together, in particular bonded together, to form a door leaf that is 20 mm thick. It is also possible to form a door leaf coated on two sides from felt layers that are coated on one side; here two felt layers, each provided with a coating on one surface, such as the vapor diffusion-proof coating, are joined together, in particular bonded together, on their non-coated surfaces. Alternatively, or in addition to bonding, the different layers of felt material can also be sewn together. Insofar as the coating has been penetrated in this process, it is advantageous to cover the regions of the seams with a further layer of vapor diffusion-proof material, and in particular to bond this covering layer. In a similar manner, other production-related breakdowns in the coating can also subsequently be re-closed and re-sealed.

In a further particular form of embodiment of the invention, the door leaf can be configured as a double door leaf. Such a double door leaf has two door leaf sections, which are arranged so that they extend parallel to each other, and are spaced apart in a direction transverse to their surface. In this manner, a cavity is formed between the two door leaf sections. At the lower end, the two door leaf sections are connected to each other. This is preferably done in a curved turn-around section of the door leaf sections, so that the two door leaf sections can be manufactured from one piece. An appropriate door leaf material is turned through 180 degrees in the region of the turn-around section, so that two spaced door leaf sections extending parallel to each other are created, which are connected to each other in the region of the turn-around section by a curved region that is essentially semicircular in cross-section, that is to say, the door leaf essentially forms a sling in cross-section. One of the door leaf sections abuts against the door frame with one or a plurality of contact regions. This door leaf section has the second magnetic holding elements described above in its contact regions. In a particular configuration, a sliding weight can be arranged in the region of the turn-around section; this preferably extends essentially over the entire width of the door leaf. The sliding weight weighs down the door leaf so that the door leaf sections are always kept stretched. In addition, it supports the unwinding of the door leaf, since it pulls the door leaf downwards by virtue of its weight. However, a configuration without a sliding weight is also possible. On the one hand, such a double door leaf has better insulation properties, but in addition, it also enables a very simple winding-on procedure and a pressing action against a door frame.

One of the door leaf sections is preferably connected at its upper end to the at least one rotatable shaft in order that the door leaf can be wound onto the latter. This is preferably the door leaf section that is spaced further apart from a door frame. The other door leaf section is preferably fixed at its upper end. Here the door leaf is preferably fixed in a region of the upper end of the door frame; furthermore, this is preferably in the region of the upper horizontal section of the door frame. A door leaf configured and arranged in this manner is wound on such that the first door leaf section is wound onto the shaft and the turn-around section moves upwards in the procedure. This results in the door leaf section that is fixed at the upper end being rolled off, or lifted off, from a door frame from its lower end during the winding-on procedure. That is to say, the door leaf section, starting from its lower end, moves upwards, and thereby in a horizontal direction, away from the door frame. This enables the door leaf to open easily, since there is essentially no friction to be overcome between the door leaf and the door frame. In an alternative configuration, however, it would also be possible not to fix the second door leaf section, but instead to connect it to a second shaft, such that the door leaf is opened by winding the two door leaf sections onto their respective shafts.

According to another possible form of embodiment, a double door leaf can be configured such that the two door leaf sections are configured with different thicknesses. Here the door leaf sections are defined as those surfaces that in the closed state extend between the top and the bottom of the door. The advantage of the different thicknesses is that, for example, the side of the door leaf facing a cold region can be made thicker, and can thus have better insulation properties, while the second door leaf section, which faces towards a warmer region, can be made thinner so as to reduce the mass of the door leaf for the winding-on procedure. The different thicknesses of the door leaf sections can be implemented, for example, in the form of a multi-layer construction, in which the thinner door leaf section has one material layer, or layer of felt material, less than the thicker section. Thus, for example, the thicker door leaf section can be configured to have two layers, and the second layer of felt material can end in the region of the lower end of the door leaf, in particular in the region of the turn-around section, while the first layer of felt material is carried through, and also forms the second door leaf section. This can also be implemented in a corresponding manner with more than two layers. Alternatively, it is possible to form the two door leaf sections as separate door leaf sections, and to join them together in the region of the lower end, that is to say, in particular, in the region of a turn-around section, for example by sewing them together. Both door leaf sections can be provided with a vapor diffusion-proof coating on one or both surfaces, as has been described above. Here it is also possible, for example, to provide only one door leaf section with a coating on both surfaces, while the other door leaf section is provided with a coating on only one side. Also, it is not essential for both door leaf sections to have vapor diffusion-proof coatings. For example, one door leaf section could have a different type of coating on at least one surface. For example, the section of the door leaf that does not face towards a cold storage room, that is to say, is not adjacent to a cold storage room, need not necessarily have a vapor diffusion-proof coating on both sides, or, in certain circumstances, need not be coated at all.

In what follows the invention is described by way of example with reference to the accompanying figures. The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which preferred embodiments of the invention are illustrated.

### BRIEF DESCRIPTION OF THE DRAWINGS

In the drawings:

FIG. 1 is a schematic plan view showing a quick-action door according to a first form of embodiment of the invention;

FIG. 2 is a side view of a quick-action door shown in FIG. 1;

FIG. 3 is a schematic plan view onto a quick-action door according to a second form of embodiment of the invention;

FIG. 4 is a side view of the quick-action door shown in FIG. 3;

FIG. 5 is a side view of the quick-action door shown in FIG. 3 in an alternative form of embodiment;

FIG. 6 is a schematic cross-sectional view through a door leaf according to the first form of embodiment;

FIG. 7 is a schematic cross-sectional view through a door leaf according to the second form of embodiment;

FIG. 8 is a cross-sectional view parallel to the surface through the door leaf shown in FIG. 6;

FIG. 9 is a plan view of a door leaf according to a further possible configuration; and

FIG. 10 is a detail view of a cross-section of the door leaf according to FIG. 9, in contact with a door frame.

### DESCRIPTION OF PREFERRED EMBODIMENTS

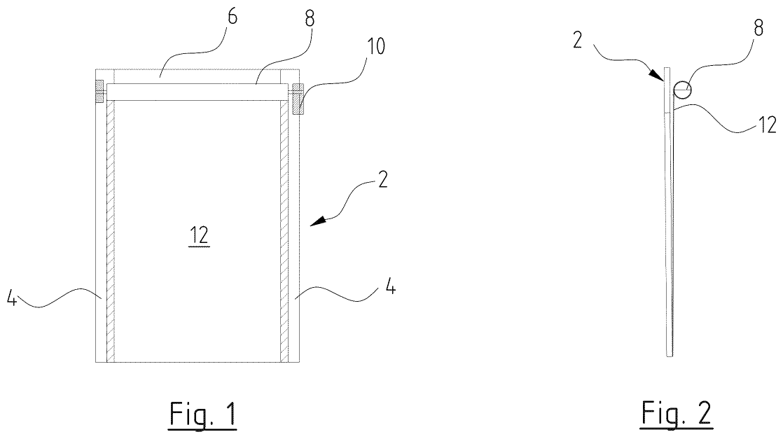

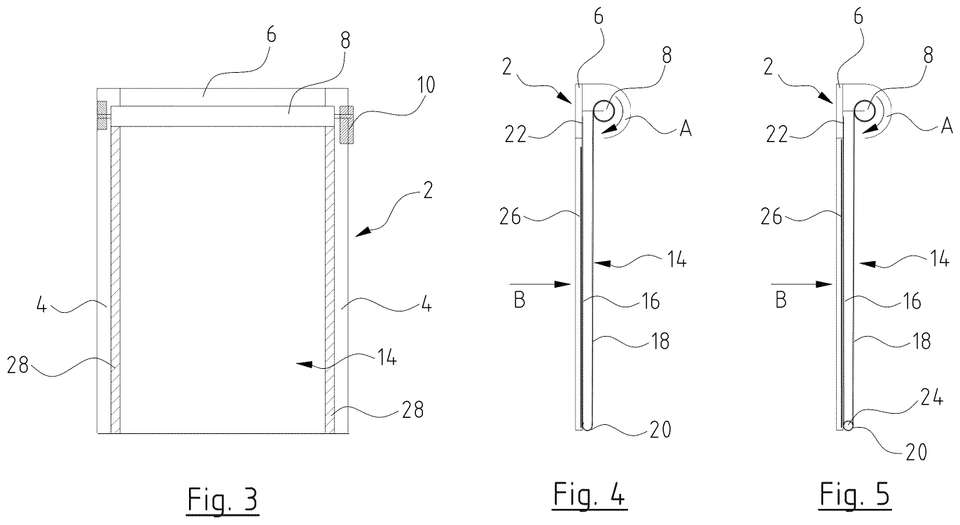

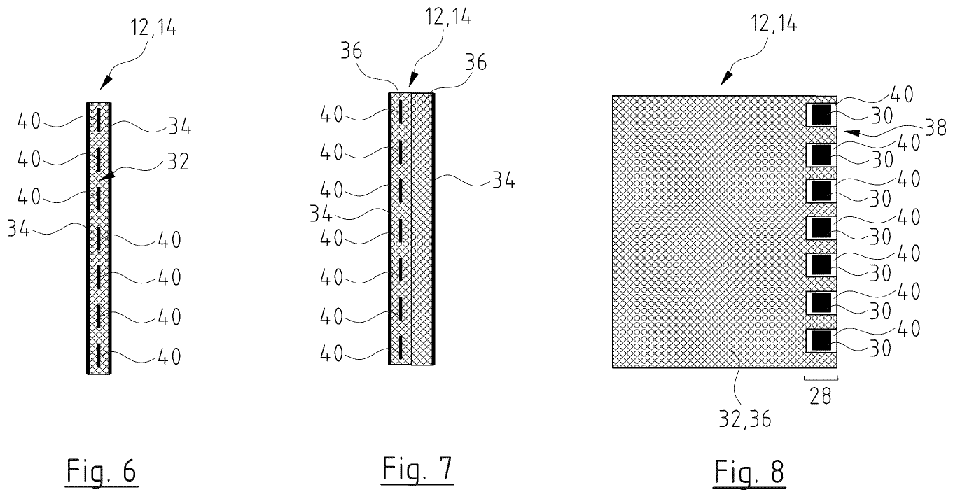

Referring to the drawings, the quick-action doors shown in FIGS. 1 and 3 have a door frame 2 formed by two lateral frame sections 4 extending essentially vertically, together with an upper frame section 6 extending horizontally. At the upper end of the door, that is to say, in the vicinity of the upper frame section 6, a rotatable shaft 8 is arranged, which extends horizontally and is driven by an electric drive motor 10. The quick-action door according to FIG. 1 also has a flexible door leaf 12, which is connected to the shaft 8 at its upper end so that the door leaf 12 can be wound onto the shaft 8 by rotating the shaft 8. For this purpose, the door leaf 12 is appropriately flexible, and is made from a felt material, as described in more detail below with reference to FIGS. 6 to 8. As can be seen in the side view of FIG. 2, in the example of embodiment in FIG. 1 a simple door leaf is provided, that is to say, there is a single door leaf section that comes into contact with the door frame 2, and can be wound onto the shaft 8.

In contrast to the example of embodiment in FIGS. 1 and 2, in the example of embodiment in FIGS. 3 to 5 a door leaf 14 is deployed that is configured as a double door leaf. As can be seen in the side views in FIGS. 4 and 5, the door leaf 14 is formed from a door leaf web that is turned around by, or turned through, 180 degrees at the lower end, such that the sling shape that can be seen in the side view in FIGS. 4 and 5 is formed. In this manner, two door leaf sections 16 and 18 are formed in the closed state; these are connected to each other at the lower end by way of a turn-around section, that is to say, a curved region 20. The first door leaf section 16, which is closer to the door frame 2 and comes into contact with the latter, is fixed at the upper end 22 to the upper frame section 6 of the door frame 2. The upper end of the second door leaf section 18 is connected to the shaft 8, that is to say, it is wound onto the shaft 8. When the shaft 8 rotates in the direction of rotation A, the second door leaf section 18 is wound onto the shaft, and, at the same time, the first door leaf section 16 is pulled off the door frame 2 from its lower end and pulled upwards. The turn-around section 20, that is to say, the curved region 20, also moves upwards, and the door opens. To close the door, the shaft 8 is turned in the opposite direction and the door slides down again accordingly, that is to say, it falls under the force of gravity. In the example of embodiment shown in FIG. 5, there is also a sliding weight 24 in the curved region 20, which preferably extends over the entire width of the door. This sliding weight 24 weighs down the door leaf 14, pulls it down and rolls in the turn-around section 20 as the door leaf 14 is opened and closed.

In order to keep the door leaf 14 in close contact with the door frame 2, a magnetic holding device is provided. In the two lateral frame sections 4, first magnetic holding elements in the form of permanent magnets are arranged for this purpose, which here are configured as magnetic strips 26. These magnetic strips can also be configured as magnetic strips on the surface of the lateral frame sections 4. In addition, it would also be conceivable to embed a multiplicity of individual magnets in the lateral frame sections 4. The door leaf 14 abuts onto the surface of the lateral frame sections 4 with lateral contact regions 28, which border the lateral edges of the door leaf. In the contact regions 28, in this first form of embodiment, second magnetic holding elements are arranged in the interior of the first door leaf section 16; these are configured as ferromagnetic metal elements in the form of metal plates 30, as can be seen in FIG. 8. FIG. 8 shows schematically a detail of the door leaf section 16. The metal platelets 30 are attracted by the magnetic force of the magnetic strip 26, so that the door leaf section, and thus the entire door leaf 14, is held against the door frame 2. Here the door leaf 14 with the door leaf section 16 only sits on the surface of the door frame 2. This has the advantage that the door leaf can be lifted off the door frame 2 in the direction of the arrow B, if sufficient force is applied to the door leaf 14. This is a safety feature because, on the one hand, the door can be opened from the side of the door frame 2 at any time simply by applying pressure on the door leaf 14 in the direction of the arrow B. In the case of cold stores or cold storage rooms, for example, this has the advantage that the door can always thus be opened from the inside. In addition, the door can also open if a transport vehicle, such as a forklift truck, should accidentally drive against the door from the inside. The door leaf 14 then simply swings open in the direction of the arrow B and afterwards falls back against the door frame 2, where it is then held again in a sealed contact. As the door leaf 14 is wound onto the shaft, the metal platelets 30 at the lower end of the door leaf 14 are pulled off the door frame 2, that is to say, the lateral frame sections 4 in the horizontal direction one after another. The arrangement of a multiplicity of metal platelets 30 ensures the mobility of the door leaf 14, which is necessary for the winding-on procedure.

A preferred further configuration of the door leaves 12, 14 is described in more detail with the aid of FIGS. 6 to 8, which show schematically a detail of a door leaf 12 or 14. The door leaf is made from felt, in particular a woolen felt. In the example of embodiment shown in FIG. 6, the door leaf 12, 14 has a woolen felt layer 32, which, on its surfaces facing away from each other, is provided with a coating 34, which is vapor diffusion-proof and is fixedly bonded to the felt material. This coating 34, which is vapor diffusion-proof, can be made, for example, from polyurethane, preferably a polyether-based polyurethane, and can be bonded, or cast, or fused, directly onto the surface of the woolen felt 32. The coating 34 is flexible, such that the door leaf 12, 14 can be repeatedly rolled up and unrolled, even at very low temperatures.

In order to design a door leaf 12, 14 of greater thickness, either a thicker layer of woolen felt 32 can be used, or, as shown in the example in FIG. 7, two layers of woolen felt 36 can be joined together, for example bonded, to form a door leaf. The woolen felt layers 36 are in each case provided with a coating 34 on one surface, and the two woolen felt layers 36 are bonded together on the sides that have no coating, so that a door leaf 12, 14 is created that is provided with a coating 34 on its two outer surfaces, facing away from each other, as has been described above. If a double door leaf 14 is configured, it would be conceivable to design the door leaf section 16 from just two woolen felt layers 36, as shown in FIG. 7, while the door leaf section 18 is configured as a single layer by extending one of the woolen felt layers 36, or by joining a thinner woolen felt to the door leaf section 16 in the region of the lower end 20.

To arrange the metal platelets 30 in the interior of the woolen felt 32 or 36, pockets 40 are incised into the felt material from the side edge 38. The metal platelets 30 are inserted into these pockets 40 from the side edge, and are bonded in the pockets 40, for example by sealing the side edges 38 with a liquid plastic compound. In the case of the double door leaf 14, such pockets 40 with the metal plate-lets 30 are preferably only configured in the door leaf section 16. In the case of the door leaf 12, 14, which is formed from two woolen felt layers 36, the pockets 40 are preferably incised into the woolen felt layer 36, which subsequently faces the door frame 2, so that the metal platelets 13 are located closer to the door frame.

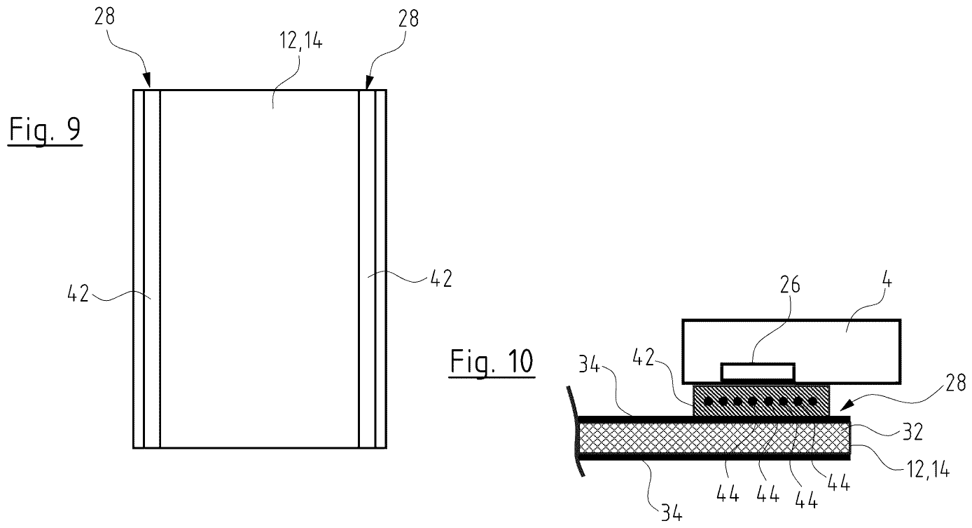

FIGS. 9 and 10 show an alternative configuration of the second magnetic holding elements. In this example of embodiment, rubber or elastic polymer contact strips 42 are glued to the door leaf 12, 14 in the contact regions 28. Steel wires 44 are embedded in the material of the contact strips 42, which form the second magnetic holding elements. Like the metal plates 30 in the first example of embodiment, these are attracted by the magnetic strips 26 in the side frame parts 4, so that the door leaf 12, 14 with the contact strips 42 is held in close contact with the door frame 2 or its side frame parts 4. The steel wires 44 are protected inside the material of the contact strip 42, in particular against corrosion.

While specific embodiments of the invention have been shown and described in detail to illustrate the application of the principles of the invention, it will be understood that the invention may be embodied otherwise without departing from such principles.

### LIST OF REFERENCE SYMBOLS

2 Door frame
4 Lateral frame sections
6 Upper frame section
8 Shaft
10 Drive motor
12, 14 Door leaf
16,18 Door leaf sections
20 Curved region, turn-around section
22 Upper end
24 Sliding weight
26 Magnetic strips
28 Contact regions
30 Metal platelets
32 Woollen felt, woollen felt layer
34 Coating
36 Woollen felt, woollen felt layer
38 Side edge
40 Pockets
42 Contact strip
44 Steel wires
A Direction of rotation
B Direction of movement

1. A quick-action door comprising:
a flexible door leaf;
at least one rotatable shaft, which is designed for the winding-on of the door leaf
a door frame against which, when the quick-action door is closed, the door leaf abuts with at least one contact region so as to form a seal;
first magnetic holding elements arranged in the door frame; and
second magnetic holding elements arranged in the door leaf in the contact region such that the door leaf is held magnetically in contact with the door frame.

2. The quick-action door according to claim 1, wherein the first magnetic holding elements are permanent magnets, and the second magnetic holding elements are ferro-magnetic metal elements.

3. The quick-action door according to claim 1, wherein the second magnetic holding elements are embedded in material of the door leaf.

4. The quick-action door according to claim 1, wherein the door leaf is made from felt material.

5. The quick-action door according to claim 4, wherein the felt material has pockets in an interior adjacent to at least one side edge, into which the second magnetic holding elements are inserted.

6. The quick-action door according to claim 1, wherein the second magnetic holding elements are embedded in a contact element, which is attached to the surface of the door leaf in the at least one contact region.

7. The quick-action door according to claim 6, wherein the at least one contact element is bonded to the door leaf.

8. The quick-action door according to claim 1, wherein the second magnetic holding elements are formed by ferromagnetic wires, which are embedded in an elastic material.

9. The quick-action door according to claim 8, wherein the ferromagnetic wires are embedded in the elastic material, which comprises at least one contact element in the form of a contact strip, which is attached to the surface of the door leaf in the at least one contact region.

10. The quick-action door according to claim 1, wherein the door leaf is provided with a vapor diffusion-proof coating on each of two surfaces of the door leaf that are facing away from each other.

11. The quick-action door according to claim 1, wherein the door leaf is made from felt material, which is a felt made from natural and/or artificial fibers.

12. The quick-action door according to claim 1, wherein the vapor diffusion-proof coating of the door leaf is made from a plastic material.

13. The quick-action door according to claim 10, wherein the vapor diffusion-proof coating of the door leaf has a flexibility enabling the door leaf to be rolled up, even at temperatures below 0 °C.

14. The quick-action door according to claim 10, wherein the vapor diffusion-proof coating of the door leaf is UV-stable.

15. The quick-action door according to claim 10, wherein the door leaf is made from felt material and the vapor diffusion-proof coating of the door leaf is bonded to the felt material of the door leaf and/or is fused onto the felt material.

16. The quick-action door according to claim 1, wherein the side edges of the felt material of the door leaf are sealed.

17. The quick-action door according to claim 1, wherein the door leaf has at least two mutually joined layers of felt material.

18. The quick-action door according to claim 1, wherein the door leaf is configured as a double door leaf with two door leaf sections, which extend in parallel and are spaced apart from one another, and which are connected to one another at lower ends thereof,.

19. The quick-action door according to claim 18, wherein one of the door leaf sections is connected at an upper end to the at least one rotatable shaft, and the other door leaf section is fixed at an upper end, or is connected to a second rotatable shaft.

20. The quick-action door according to claim 18, wherein the two door leaf sections are configured to be of different thicknesses.
